(19) United States
(12) Patent Application Publication
(10) Pub. No.: US 2020/0154739 A1
(43) Pub. Date: May 21, 2020

(54) FLAVORERD PROTEIN BEVERAGE AND METHOD OF MAKING THE SAME

(71) Applicant: Kings Farm Foods Limited, Suffolk (GB)

(72) Inventor: Matthew Havers, Suffolk (GB)

(73) Assignee: Kings Farm Foods Limited, Suffolk (GB)

(21) Appl. No.: 16/686,611

(22) Filed: Nov. 18, 2019

Related U.S. Application Data
(60) Provisional application No. 62/769,719, filed on Nov. 20, 2018.

(51) Int. Cl. A23L 2/66; A23L 2/02; A23L 2/56; A23L 2/68; A23L 2/60; A23L 2/46; A23L 2/72; A23J 1/08

(52) U.S. Cl. CPC A23L 2/66; A23L 2/02; A23L 2/56; A23L 2/68; A23V 2002/00; A23L 2/46; A23L 2/72; A23J 1/08; A23L 2/60

(57) ABSTRACT

A flavored protein beverages include egg whites, water, a plant-based milk, a juice component, flavoring, a thickening agent, and an acidifier. The egg whites constitute a majority of the weight of the beverage and serve as the primary source of protein. The acidifier is malic acid, and the pH of the protein beverage is between about 4 and about 4.6. The pH value of 4.6 is significant because Clostridium botulinum cannot grow and produce toxin below this value, whereas the taste of the beverage when the pH is below 4.0 has been found to be unacceptable. After pasteurization, the flavored beverage has a shelf life of up to about six (6) months without refrigeration and without the use of non-natural preservatives. A pH between about 4.2 and 4.3 is best to optimize taste throughout the entire shelf life.

### INTRODUCTION

Eggs, and in particular egg whites, are excellent sources of natural dietary protein. In order to make egg whites fit for consumption, they are typically cooked. Pasteurized liquid egg whites are sold primarily for use in recipes. Uncooked, pasteurized liquid egg whites may be consumed without cooking but a large number of consumers are reluctant to consume uncooked, pasteurized liquid egg whites as a drink given their slimy texture and unappetizing taste. Accordingly, several companies have created beverages in which sweeteners and flavors have been added to pasteurized egg whites to improve their taste. Some of these beverages use pasteurized, natural liquid eggs and some use rehydrated powered egg whites. However, the mucilaginous texture imparted by the egg whites remains challenging to many consumers. Egg white based beverages are also susceptible to microbial contamination and spoilage which limits their shelf-lives and often necessitates the need for refrigeration during storage. To address this problem, several companies have created egg white based beverages that contain stabilizers, allowing them to be frozen for up to a year. Other available products contain added preservatives, which allow these beverages to be conveniently stored at room temperature for several weeks. However, for consumers that are wary of artificial preservatives, this is an imperfect solution. Thus, there is a need in the art for new, all natural egg white-based beverages that have an appealing taste and that do not spoil readily.

### SUMMARY

The present invention relates to flavored protein beverage compositions. The flavored protein beverages include egg whites, water, a plant-based milk, a juice component, flavoring, a thickening agent, and an acidifier. The egg whites constitute a majority of the weight of the beverage and serve as the primary source of protein. Desirably, the protein beverage also includes a natural sweetener and natural flavoring. In a preferred embodiment, the flavored protein beverage includes natural liquid egg whites between about 50% and about 85% (w/v), water, a plant-based milk, a juice component, flavoring, sweetener, a thickening agent such as pectin, and an acidifier such as malic acid, wherein the pH of the protein beverage is between about 4 and about 4.6. The pH value of 4.6 is significant because Clostridium botulinum cannot grow and produce toxin below this value (see, for example, U.S. F.D.A. 21 CFR 114.80). On the other hand, the taste of the beverage when the pH is below 4.0 has been found to be unacceptable. After pasteurization the flavored beverage has a shelf life of up to about six (6) months without refrigeration and without the use of non-natural preservatives. More preferably, the pH of the flavored protein beverage is between about 4.2 and 4.3. This range of pH provides the best taste over the entire shelf life of the product. When the pH is 4.0-4.1, the taste is tart at first but the tartness fades with time. When the pH is 4.4-4.6, the taste at the end of the six-month shelf life is not as desirable as if the pH is 4.2-4.3.

The preferred compositions provide a lactose-free flavored beverage, high in protein and low in sugar. As described herein, various additives or supplements can be added in moderation without effecting the overall drinkability of the flavored protein beverage. Another aspect of the invention is directed to a method for making the flavored protein beverage. Initially, if pectin is used as a thickener, dried pectin is rehydrated with water at about 75° C. Then, a preliminary blend is created. This step includes generally mixing together a plant-based milk, a juice component, the rehydrated pectin thickening agent, flavoring, sweetener, coloring and malic acid as an acidifier. This first mixing step to form the preliminary blend typically occurs at a mixing temperature of between about 20° C. to about 25° C. and can be a high sheer mixing step, e.g. about 2,500 rpm. Then, the liquid egg whites and remaining water are added to the preliminary blend and mixed during a second mixing step to form the protein beverage. The second mixing step is a low sheer mixing step, e.g. about 750 rpm. The amount of liquid egg whites added to the preliminary blend is such that the weight of the liquid egg whites comprises a majority of the weight of the protein beverage. The amount of the malic acid renders the pH of the protein beverage to be between about 4 and about 4.6, and preferably between 4.2 and 4.3 as mentioned above.

The protein beverage is pasteurized at a pasteurization temperature between about 50° C. to about 57° C., depending on the pasteurization technology used. The beverage can be bottled prior to pasteurization and the bottled beverage can be pasteurized by placing the bottle in a warm water bath, e.g. 53° C. The pasteurized protein beverage is cooled after pasteurization, and has an unrefrigerated shelf life of six (6) months.

Other methods may be suitable for producing the protein beverages described herein, however, the particular method described by the inventors produces particularly reliable results in terms of taste and consistency.

### BRIEF DESCRIPTION OF DRAWINGS

FIG. 1 shows a flow diagram for a method of making a protein beverage.

FIG. 2 shows a drawing of a bottle of the protein beverage.

### DETAILED DESCRIPTION

Here, the present inventor discloses flavored protein beverage compositions that include pasteurized liquid egg whites as a natural source of dietary protein. The liquid egg whites comprise a majority of the weight of the beverage. The inventor further discloses a method of making such flavored protein beverage compositions. The inventor has discovered that the palatability and consistency, as well as the shelf-life of uncooked, liquid pasturized egg whites, is improved by combining the liquid egg whites with certain proportions of water, a plant-based milk, a juice component, a thickening agent, natural flavorings, a sweetener such as stevia, and an acidifier, namely malic acid. The inventor further demonstrates that following pasteurization, the disclosed protein beverages may be stored at room temperature without significant microbial spoilage or growth for several months, i.e. 6-month non-refrigerated shelf life. The disclosed flavored protein beverages are appealing to consumers as natural, good-tasting high protein beverages that may be produced to be free of lactose, whey, artificial sweeteners, and/or artificial preservatives.

Flavored Protein Beverage Compositions

As mentioned, in one aspect, the present invention relates to flavored protein beverage compositions. The protein beverages includes egg whites, water, a plant-based milk, a juice component, a thickening agent, natural flavorings, and an acidifier. Optionally and desirably, the protein beverages may further include a sweetener, as well as other additives if desired.

The flavored protein beverage compositions includes liquid egg whites within a desired targeted range of between about 50% and about 85% (w/v). In the preferred embodiments, the liquid egg whites amount to about 66% (w/v), or 61.6% of the weight of the beverage. The other ingredients as mentioned include water, a plant-based milk, a juice component, a thickening agent, stevia as a sweetener, one or more natural flavorings, and malic acid as an acidifier. As mentioned, malic acid is added so that the pH of the flavored protein beverage is between about 4 and about 4.6, and preferably between about 4.2 and 4.3. The beverage is preferably bottled and then pasteurized in the bottle. The shelf life of the pasteurized product without refrigeration is at least six (6) months.

As used herein, “about” and “approximately” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

The percentages disclosed herein are generally provided on a “weight/volume” or “(w/v)” basis. The % (w/v) of a component in a composition disclosed herein is determined by dividing the weight of the component added to the composition as measured in kilograms by a total volume of the final composition of 100 liters. For example, if the weight of a component (“component A”) added to a composition is 66 kilograms and the final total volume of the composition is 100 liters, the % (w/v) of component A in the composition is 66% (w/v). Exemplary non-limiting components and their percentage ranges that may be used to make the flavored protein beverages disclosed herein are provided in the Examples. See, e.g., Tables 1-3. Some suitable substitutes for these components are also discussed herein although others may be readily apparent to those of skill in the art.

As used herein, the terms “egg white” or “egg whites” refers to the clear liquid contained within an egg, sometime called the albumen. Suitably, the egg whites may be from a bird egg including, without limitation, a chicken egg. Natural liquid egg whites are separated from the egg yolk, and can take the form of pasteurized liquid egg whites as is known to be commercially available. The preferred embodiments of the invention as disclosed herein use pasteurized natural egg whites. Dried and powered egg whites can be reconstituted and used as a substitute for natural liquid egg whites in accordance with the invention although not preferred.

The natural liquid egg whites in the flavored protein beverages produced in accordance with the invention constitute a majority of the weight of the beverage, and may constitute between about 50% and about 85% (w/v), and desirably in the most preferred embodiments about 66% (w/v). The amount of the other ingredients should be selected within the disclosed ranges in order to provide the appropriate taste, texture and pH of the resulting flavored protein beverage.

In some embodiments, the water in the protein beverages may be between about 18% and about 40% (w/v). In the disclosed examples, the amount of water is about 27% (w/v). The amount of water can be adjusted to render the beverage more or less viscous depending on processing requirements and on the followability and drinkability requirements of the final product.

As used herein, a “plant-based milk” refers to a non-dairy milk substitute made from a plant or plant product. The plant-based milk may be, without limitation, soy milk, oat milk, hemp milk, rice milk, pea milk, almond milk, cashew milk, or coconut milk. Prior to incorporation into the protein beverage, the plant-based milk may be in dried, powder, or liquid form. For example, in the disclosed, non-limiting examples, soya milk powder is used to add soy milk. The soya milk powder in these examples was about 50% by weight protein. Other soya milk powder with higher or lower percentages of protein by weight may be used to deliver the desired amount of protein in the protein beverages.

The purpose of the plant-based milk is to provide a foundation in the beverage on which to build flavors. The plant-based milk mask the texture of the liquid egg and has a relatively neutral flavor. The amount of plant-based milk is desirably between about 1% and about 6% (w/v). Below this range, it is not likely to serve the purpose of masking the texture of the egg white and laying a foundation for flavoring. Too much plant-based milk, however, will lead to grittiness and settling of particulates and will also require the use of too much flavoring to overcome the taste of the plant-based milk, which is also not desirable.

Because the flavored protein beverages include a plant-based milk, they may be made without dairy milk. Accordingly, the flavored protein beverage may be essentially free of lactose or other dairy product.

As used herein, a “juice component” refers to a natural source of sugar. The juice component may be, without limitation, a juice concentrate, grape juice, grape juice concentrate apple juice, apple juice concentrate, or the like such as date or fructose syrup. Suitably, the juice component is grape juice or grape juice concentrate (i.e., white grape juice concentrate). In some embodiments, the juice component has a brix value of between about 60 and about 70, about 62 and about 64, or any range therein. The juice component may be rectified removing fruit components other than sugars such as glucose, fructose, sucrose, and other saccharides. Prior to incorporation into the protein beverages, the juice component may be in dried, liquid, or puree form.

The juice component in the protein beverages may be between about 3% and about 10% (w/v). The sugar in the juice helps the pectin dissolve and hydrate more efficiently, so using at least 3% (w/v) is desirable. Above 10% (w/v), the juice component is likely to negatively after taste of the beverage.

As used herein, a “thickening agent” may include, without limitation, pectin, gelatin, gellan gum, xanthum gum, guar gum, or other like agents.

The thickening agent in the disclosed protein beverages is pectin and comprises between about 0.05% and about 0.30% (w/v), or preferably between about 0.15% (w/v). Using more pectin will increase the viscosity too much for production purposes or for drinkability. Below the 0.05% level is not likely to provide enough thickening benefit. In the non-limiting Examples, GENU® pectin (type YM-115-H, E440 Pectin standardized with sucrose, CAS: 9000-69-5 57-50-1) is used. Thickening agents with similar characteristics to GENU® pectin may be used to achieve the desired mouth feel and/or emulsifying/stabilizing properties.

This invention uses malic acid as an “acidifier” although it is contemplated that acidifiers other than malic acid can be used in addition to malic acid such as citric acid, lemon juice, vinegar, or lactic acid. Suitably, the acidifiers adjust the pH of the protein beverage to the desired pH of between about 4 to about 4.6, and preferably between about 4.2 and 4.3.

In the disclosed examples, the only acidifier used is malic acid, and the amount of malic acid in the protein beverages is about 1.2% (w/v). The amount of malic acid should be adjusted to achieve the appropriate pH, which means that the range of malic acid should normally be between about 0.5% and about 1.5% (w/v) and preferably about 1.2% (w/v).

The “sweetener” may be, without limitation, stevia, sucralose, aspartame, or saccharin, although stevia is preferred.

The stevia sweetener in the disclosed protein beverages may be between about 0.02% and about 0.06% (w/v) or any range therein. Suitably, the stevia sweetener in the disclosed protein beverages may be between about 0.03% and about 0.05% (w/v).

The “natural flavoring” may include extracts or additives having fruit, vegetable, or herbal flavors. Suitable natural flavoring may include, without limitation, extracts or additives having strawberry, lime, mango, passionfruit, raspberry, blueberry, or any combination thereof flavors.

The natural flavoring in the disclosed protein beverages will typically be less than 1% (w/v), and should be added to taste.

It may also be helpful to add an emulsifying agent such as soya lecithin liquid, as needed.

As mention previously, the pH of the flavored protein beverages disclosed herein is between about 4 and about 4.6. When the pH of the protein beverage is below 4.0, the taste is too acidic especially within the first 90 days of product life. The pH value of 4.6 is significant because Clostridium botulinum cannot grow and produce toxin below this value. A pH in the range of 4.2 to 4.3 provides optimum taste throughout the entire shelf life of the product. While a pH of 4.4 to 4.6 is acceptable, taste can start to deteriorate towards the end of the six month shelf life so the pH levels are not preferred.

It is contemplated that the flavored protein beverage will be pasteurized, and that the pasteurization will normally occur after the beverage is bottled. Particular pasteurization conditions suitable for the disclosed protein beverages are provided in the methods and Examples discussed below. Care must be taken so that the pasteurization temperature does not cause the egg white to cook.

Desirably, the flavored protein beverage compositions are essentially free of non-natural preservatives. Non-natural preservatives may include, without limitation, sodium benzoate or potassium sorbate.

The protein beverages may further include a nutrient, an herbal supplement, calcium or a calcium derivative, an energy-generating additive such as caffeine, or a coloring agent.

The amount of total protein in the disclosed protein beverages is typically between about 15 grams and about 25 grams per 250 mL serving, and more desirably between 18 grams and about 22 grams per 250 mL serving. If more protein is desired, powered egg white can be added to the formulation.

The amount of total sugar in the disclosed protein beverages is typically between about 1 grams and about 15 grams per 100 mL serving, and more desirably between about 2 grams and about 10 grams per 100 mL serving, or any range therein.

Exemplary Method for Making the Flavored Protein Beverage

The disclosed exemplary method for making the described protein beverage generally involves two primary mixing steps. In a first mixing step, a preliminary blend of ingredients is mixed desirably via high sheer mixing. The liquid egg whites are not added in this step. The liquid egg whites are added in a second mixing step that uses low sheer mixing. The preliminary blend includes generally the following ingredients: a plant-based milk, a juice component, a thickening agent such as pectin, an acidifier (malic acid), flavoring, coloring, and a sweetener such as stevia. If pectin is used, it is desirable to rehydrate the pectin as mention in hot water (75° C.) prior to adding the other ingredients of the preliminary blend. The liquid egg whites are sieved prior to adding the liquid egg whites and any remaining water in the second mixing step, which is a low sheer mixing step. After mixing, the protein beverage is pasteurized.

As used herein, the term “mixing” refers to the process of combining ingredients together. “Mixing” may be accomplished by any appropriate means known in the art including, without limitation, hand-stirring or use of mixer such a propeller-type mixer, blender, etc. The rate of mixing may be generally between about 100 rpm to about 5000 rpm, although the term “low sheer mixing” is used in the context of this invention to describe mixing speeds of equal to or less than 1000 rpm, and the term “high sheer mixing” is used in the context of this invention to describe mixing speeds of greater than 1000 rpm.

In embodiments where the egg whites are added to the primary blend after the addition or mixing of the other ingredients, it is desirable to mix the liquid egg whites at a low mixing rate of between about 100 rpm to about 1000 rpm, between about 200 rpm to about 800 rpm, or any range therein. In the examples below, low sheer mixing rate used after the liquid egg whites are added is about 750 rpm.

The mixing temperature may be between about 18° C. to about 28° C., between about 20° C. to about 25° C., between about 21° C. to about 24° C., or any range therein. Suitably, the mixing temperature is about room temperature or about 23° C.

As used herein, the term “pasteurizing” refers to the processing of sterilizing a product so as to make it safe for consumption. Pasteurization of the protein beverage may be accomplished by heat treatment. The heat treatment may be applied to the protein beverage prior to, during, or after bottling.

If after bottling, and in a warm water bath, the preferred pasteurization temperature is about 53° C. Higher temperatures could cause unwanted denaturation of the liquid egg whites and/or coagulation. Using a slightly lower pasteurization temperature is acceptable, but may cause the time for pasteurization to be excessive. The pasteurization time in a warm water bath is about 120 minutes if the pasteurization temperature is 53° C. Different pasteurization technologies can be used, and these technologies may, e.g., use higher pasteurization temperatures with lower pasteurization times.

As mentioned, the pectin or another thickening agent may be rehydrated prior to its addition to the preliminary blend. Preferably, the pectin is rehydrated with water for about 5 minutes at about 75° C.

Generally speaking, the method may include one or more of the following steps. Initially, a mixer is run at a high sheer rate between about 2,000 rpm to about 3,000 rpm. First, 150 g of thickening agent is rehydrated in a tank by adding up to 1.4 kg of water (5% of total water by weight) and mixing for between about 1 minute to about 10 minutes, at a temperature between about 70° C. to about 80° C. The water may be purified water, treated in a manner commonly used in the beverage industry. The following additions are performed sequentially at room temperature (about 23° C.): 3 kg of juice component is added and incorporated through about 1 minute to about 10 minutes of high sheer mixing (˜2500 RPM), 4.5 kg of plant-based milk is added incrementally, and 1.2 kg of acidifier and 40 g of an optional sweetener are added and allowed to mix for an additional 1 to 10 minutes. At this point, any additional emulsifiers or thickeners are also added. Next, an additional 3 kg of juice component is rehydrated with water and added along with roughly 300 g of natural flavoring and 300 g of flavor additives. After the ingredients have been allowed to mix for 1 to 10 minutes, the resulting mixture is sieved to remove any remaining lumps of undissolved powder. Then, the mixer speed is reduced to a low sheer rate of about 200 rpm to about 1000 rpm. Sixty six (66) kg of liquid egg whites are sieved to remove coagulated protein before being are added to the mix along with the remaining water (to reach a total of 27.65 kg added water). After 5 minutes of low sheer mixing, the mixture is tested to ensure that a pH within the target range of 4.2-4.3 has been achieved. The resulting flavored protein beverage may be bottled and sealed. The product may then be pasteurized in the sealed containers by incubation in warm water baths. The bottles are then cooled in a circulatory cold water bath.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference in their entirety, unless explicitly indicated otherwise. The present disclosure shall control in the event there are any disparities between any definitions and/or description found in the cited references.

Unless otherwise specified or indicated by context, the terms “a”, “an”, and “the” mean “one or more.” For example, “a protein” should be interpreted to mean “one or more proteins.”

The following examples are meant only to be illustrative and are not meant as limitations on the scope of the invention or of the appended claims.

### EXAMPLES

### Example 1—Methods of Making Protein Beverage Compositions

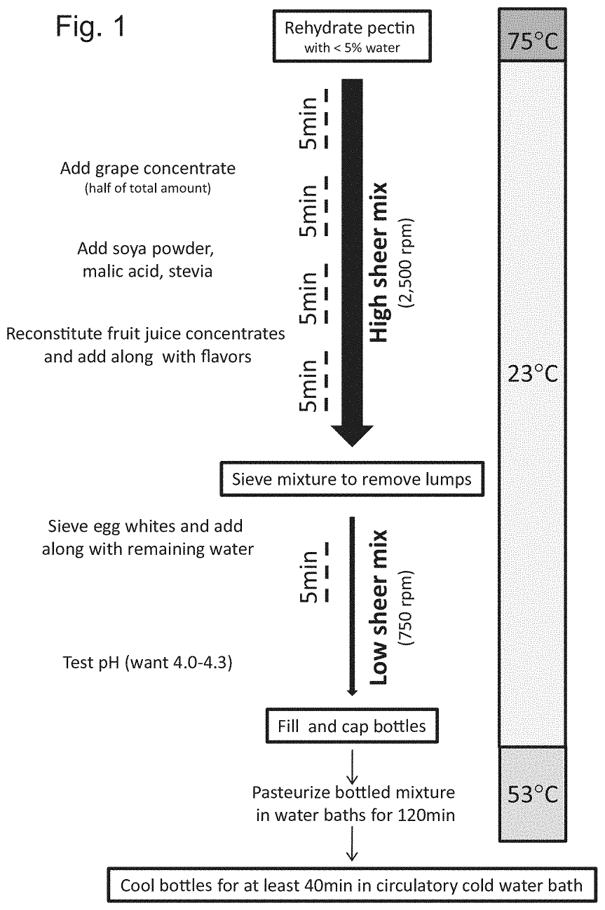

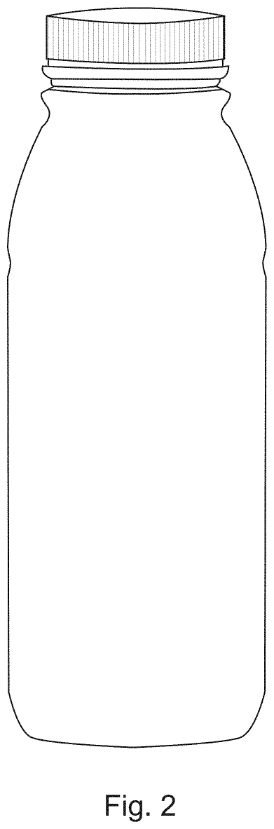

This example is for the preparation of a 100 liter batch of a protein beverage. A schematic flow diagram summarizing this example is also provided as FIG. 1. A mixing tank with a propeller prop mixer may be used. Initially, the mixer is run at a high sheer rate of about 2,500 RPM. First, 150 g of pectin is rehydrated in the tank by adding up to 1.4 kg of water (5% of total water by weight) and mixing for about 5 minutes at 75° C. The water may be purified water, treated in a manner commonly used in the beverage industry. The following additions are performed sequentially at room temperature, roughly 23° C.: 3 kg of deionized grape concentrate is added and incorporated through 5 minutes of high sheer mixing, 4.5 kg of soya milk powder is added incrementally, and 1.2 kg of malic acid and 40 g of stevia are added and allowed to mix for an additional 5 minutes. At this point, any additional emulsifiers or thickeners are also added. Next, an additional 3 kg of deionized grape concentrate is rehydrated with water and added along with roughly 300 g of additional fruit concentrates and 300 g of flavor additives. After the ingredients have been allowed to mix for 5 minutes, the resulting mixture is sieved to remove any remaining lumps of undissolved powder. At this point, the mixer speed is reduced to a low sheer rate of about 750 rpm. 66 kg of liquid egg whites are sieved to remove any coagulated protein before they are added to the mix along with the remaining water (to reach a total of 27.65 kg added water). After 5 minutes of low sheer mixing, the mixture is tested to ensure that a pH within the target range of 4.0-4.3 has been achieved. The resulting protein beverage is bottled into 250 ml PET bottles available from Esterform, Tenbury Wells, UK, see e.g., FIG. 2 The bottles are capped with Owens™ 28 mm closures, available from Owens, Inc., Toledo, Ohio and sealed. The product is pasteurized in the sealed containers by incubation in water baths heated to 53° C. for 120 minutes. The bottles are then cooled in a circulatory cold water bath for 40 minutes.

### Example 2—Protein Beverage Compositions

Following the procedure outlined in Example 1 and shown in FIG. 1, is followed to produce three different types of protein beverages, each with a different natural flavoring profile. A picture of a bottled protein beverage is provided as FIG. 2. The compositions of the three types of protein beverages are shown in Tables 1 thorough 3.

TABLE 1
Raspberry blueberry protein beverage

| | Amount (kg) | % of | Tolerable |
|---|---|---|---|
| | per 100 L | ingredient | Limit |
| Ingredient | product | (w/v) | Estimate |
| egg white | 66.00 | 66% | 50%-85% |
| soya milk powder | 4.50 | 4.50% | 1%-6% |
| deionised grape concentrate | 6.00 | 6% | 3%-10% |
| raspberry/blueberry | 1.00 | 1% | 0.1%-10% |
| concentrate | | | |
| stevia mask 80309 | 0.10 | 0.10% | as needed |
| soya lecathin liquid dfi | 0.40 | 0.40% | as needed |
| 965520v02 | | | |
| genu pectin ym115h | 0.15 | 0.15% | 0.05%-0.30% |
| black carrot | 0.20 | 0.20% | 0.1%-0.3% |
| malic acid | 1.00 | 1% | 0.8%-1.5% |
| stevia 60 | 0.04 | 0.04% | 0.02%-0.06% |
| raspberry 3182040049 | 0.20 | 0.20% | 0.1%-0.4% |
| blueberry cln 8192 | 0.10 | 0.10% | 0.05%-0.15% |
| Added water content: | 27.55 | 27.55% | 18-40% |
| | | Target pH: | 4.2 |

TABLE 2
Strawberry lime protein beverage

| | Amount (kg) | % of | Tolerable |
|---|---|---|---|
| | per 100 L | ingredient | Limit |
| Ingredient | product | (w/v) | Estimate |
| egg white | 66.00 | 66% | 50%-85% |
| soya milk powder | 4.50 | 4.50% | 1%-6% |
| deionised grape concentrate | 6.00 | 6% | 3%-10% |
| strawberry/lime concentrate | 0.20 | 0.20% | 0.1%-10% |
| stevia mask 80309 | 0.10 | 0.10% | as needed |
| soya lecathin liquid dfi | 0.40 | 0.40% | as needed |
| 965520v02 | | | |
| genu pectin ym115h | 0.15 | 0.15% | 0.05%-0.30% |
| black carrot | 0.10 | 0.10% | 0.1%-0.3% |
| malic acid | 1.20 | 1.20% | 0.8%-1.5% |
| stevia 60 | 0.04 | 0.04% | 0.02%-0.06% |
| strawberry | 0.20 | 0.20% | 0.1%-0.4% |
| 31820300870000 | | | |
| lime 82078 | 0.10 | 0.10% | 0.05%-0.15% |
| Added water content: | 27.65 | 27.65% | 18-40% |

| | |
|---|---|
| Target pH: | 4.2 |

TABLE 3
Mango passionfruit protein beverage

| | Amount (kg) | % of | Tolerable |
|---|---|---|---|
| | per 100 L | ingredient | Limit |
| Ingredient | product | (w/v) | Estimate |
| egg white | 66.00 | 66% | 50%-85% |
| soya milk powder | 4.50 | 4.50% | 1%-6% |
| deionised grape concentrate | 6.00 | 6% | 3%-10% |
| mango/passionfruit | 0.20 | 0.20% | 0.1%-10% |
| concentrate | | | |
| stevia mask 80309 | 0.10 | 0.10% | as needed |
| soya lecathin liquid dfi | 0.40 | 0.40% | as needed |
| 965520v02 | | | |
| genu pectin ym115h | 0.15 | 0.15% | 0.05%-0.30% |
| malic | 1.20 | 1.20% | 0.8%-1.5% |
| stevia 60 | 0.04 | 0.04% | 0.02%-0.06% |
| mango 3182501336 | 0.20 | 0.20% | 0.1%-0.4% |
| passionfruit 39300016520000 | 0.10 | 0.10% | 0.05%-0.15% |
| Added water content: | 27.75 | 27.75% | 18-40% |
| | | Target pH: | 4.2 |

Additional information for the ingredients discussed in t Examples a 1 and 2 is provided in Table 4.

TABLE 4
Ingredient Characteristics

| Ingredient | Characteristics |
|---|---|
| soya milk powder | soya milk powder (50% by weight protein) |
| deionised grape | white grape juice concentrate rectified, |
| concentrate | Specifications: Brix value between 64 and 66 |
| genu pectin ym115h | GENU ® pectin type YM-115-H, |
| | E440 Pectin standardized with sucrose, CAS: |
| | 9000-69-5, 57-50-1 |
| malic acid | DL Malic Acid 25-100 Mesh, Specifications: |
| | Assay 99-100.5% |

### Example 3—Accelerated Shelf-life Testing of Protein Beverages

To determine whether the protein beverages discussed in Examples 1 and 2 had desirable shelf-lives at room temperature, we performed accelerated shelf-life testing of the protein beverages at 37° C. Briefly, two samples of protein beverages designated as “Sample 1” and “Sample 2” were stored at 37° C. for 120 days. Each sample had a pH between about 4.2 and about 4.3. After 120 days, each sample was subjected to microbial testing. As shown in Tables 5 and Table 6, neither sample showed any substantial microbial contamination. The accelerated test are sufficient to show that the tested product has a minimum 6 month shelf life.

TABLE 5
Microbial Testing of Sample 1

| Test | Result | Unit |
|---|---|---|
| E. coli (β-Glucuronidase Positive) | <10 | cfu/g |
| Presumptive Enterobacteriaceae | <10 | cfu/g |
| Total Viable Count @30° C. for 48 hrs | 10 | cfu/g |
| Presumptive Bacillus Cereus | <20 | cfu/g |
| S. aureus (Coag. Pos. Staphylococci) | <20 | cfu/g |
| Salmonella | Not Detected | in 25 g |
| Listeria | Not Detected | in 25 g |
| Moulds | <20 | cfu/g |
| Yeasts | <20 | cfu/g |

TABLE 6
Microbial Testing of Sample 2

| Test | Result | Unit |
|---|---|---|
| E. coli (β-Glucuronidase Positive) | <10 | cfu/g |
| Presumptive Enterobacteriaceae | <10 | cfu/g |
| Total Viable Count @30° C. for 48 hrs | <10 | cfu/g |
| Presumptive Bacillus Cereus | <20 | cfu/g |
| S. aureus (Coag. Pos. Staphylococci) | <20 | cfu/g |
| Salmonella | Not Detected | in 25 g |
| Listeria | Not Detected | in 25 g |
| Moulds | <20 | cfu/g |
| Yeasts | <20 | cfu/g |

We claim:

1. A flavored protein beverage comprising:
liquid egg whites comprising at least a majority of the weight of the protein beverage;
water;
a plant-based milk;
a juice component;
flavoring
a thickening agent; and
an acidifier comprising malic acid; and
wherein the protein beverage is pasteurized, has a pH between about 4 and about 4.6 and has a shelf-life without refrigeration for up to about six months.

2. The protein beverage of claim 1, wherein the pH of the protein beverage is between about 4.2 and about 4.3.

3. The protein beverage of claim 1 wherein the liquid egg whites are natural, pasteurized liquid egg whites.

4. The protein beverage of claim 3 wherein the liquid egg whites comprises between about 50% and about 85% (w/v) of the protein beverage.

5. The protein beverage of claim 1, wherein the thickening agent is pectin.

6. The protein beverage of claim 4, wherein the malic acid comprises between about 0.8% and about 1.5% (w/v) of the protein beverage; the thickening agent is pectin and comprises between about 0.10% and about 0.30% (w/v) of the protein beverage; and the juice component is white grape juice concentrate rectified and comprises between about 3% and about 10% (w/v) of the protein beverage.

7. The protein beverage of claim 6, wherein the plant-based milk is added as soy milk powder (50% protein by weight) between about 1% and about 6% (w/v) of the protein beverage, and the protein beverage is essentially lactose free.

8. The protein beverage of claim 1, further comprising stevia as a sweetener

9. The protein beverage of claim 1 further comprising at least one of the following: a natural flavoring, a nutrient supplement, vitamin and/or mineral fortification, powered egg white or a coloring agent.

10. The protein beverage of claim 1, wherein the protein beverage is essentially free of non-natural preservatives.

11. The protein beverage of claim 1, wherein the protein beverage comprises between about 15 grams and about 25 grams of total protein per 250 mL serving.

12. The protein beverage of claim 1, wherein the protein beverage comprises between about 2 grams and about 10 grams of total sugar per 100 mL serving.

13. The protein beverage of claim 1, wherein liquid egg whites comprise rehydrated powered egg whites, or a combination of natural, pasteurized liquid egg whites and rehydrated powered egg whites.

14. A method for making a flavored protein beverage comprising:
mixing at water, a plant-based milk, a juice component, a thickening agent, flavoring and malic acid as an acidifier at a mixing temperature of between about 20° C. to about 25° C. during a first mixing step to form a preliminary blend;
adding liquid egg whites and water to the preliminary blend and mixing during a second mixing step to form the protein beverage, wherein the amount of liquid egg whites added to the preliminary blend is such that the weight of the liquid egg whites comprises a majority of the weight of the protein beverage, and wherein the amount of the malic acid renders the pH of the flavored protein beverage to be between about 4 and about 4.6;
pasteurizing the flavored protein beverage at a pasteurization temperature between about 50° C. to about 57° C.; and
cooling the pasteurized, flavored protein beverage after pasteurization.

15. The method of claim 14, wherein the flavored protein beverage is bottled prior to pasteurization, and pasteurization is achieved by placing the filled bottles in a warm water bath, wherein the pasteurization temperature is about 53° C. and the pasteurization time is about 120 minutes.

16. The method of claim 14, wherein the second mixing step is a low sheer mixing step at a rate of less than 1,000 RPM.

17. The method of acclaim 14, wherein the thickening agent is pectin between about 0.10% and about 0.30% (w/v), and the pectin is rehydrated with water for about 5 minutes at about 75° C. prior to its addition to the preliminary blend.

18. The method of claim 14, wherein the liquid egg whites are sieved prior to remove coagulated protein prior to adding the liquid egg whites to the preliminary blend.

19. The method of claim 14, wherein a sweetener comprising stevia is also added to the preliminary blend for the first mixing step.

20. The method of claim 14, wherein the pH of the flavored protein beverage is between about 4.2 and about 4.3.
